(19) United States
(12) Patent Application Publication
(10) Pub. No.: US 2019/0295176 A1
(43) Pub. Date: Sep. 26, 2019

(54) Asset Allocation and Portfolio Rebalancing via an Economy's Relative Information Processing Ratio

(71) Applicant: Edgar Parker, JR., Bayonne, NJ (US)

(72) Inventor: Edgar Parker, JR., Bayonne, NJ (US)

(21) Appl. No.: 16/359,999

(22) Filed: Mar. 20, 2019

Related U.S. Application Data
(60) Provisional application No. 62/645,174, filed on Mar. 20, 2018.

(51) Int. Cl. G06Q 40/06; G06F 17/13

(52) U.S. Cl. CPC G06Q 40/06; G06F 17/13

(57) ABSTRACT

An invention for managing assets in one or more investment funds in response to the evolution of an economy's relative information processing cycle (IPC): Specifically, and the level and variance of the economy's relative information processing ratio (IPR). A fund comprises a plurality of assets (e.g., stocks, bonds, currencies, gold, silver, oil, gas, cryptocurrencies such as bitcoin, ethereum, and the like, and cryptocurrencies which themselves are portfolios of plurality of assets, and cryptocurrencies whose value is determined by other assets). As the economy's relative information processing cycle (IPC) evolves and the relative information processing ratio rises the portfolio may be adjusted to become less conservative. As economy's relative information processing cycle (IPC) and relative information processing ratio (IPR) falls the portfolio may be adjusted to become more conservative. As the economy's relative information processing cycle (IPC) evolves and the relative information processing ratio variance rises the portfolio may be adjusted to become more conservative. As economy's relative information processing cycle (IPC) and relative information processing ratio variance (IPR) falls the portfolio may be adjusted to become less conservative. The level and variance of relative information processing ratio may be used in conjunction to adjust a portfolio.

An invention for managing assets in one or more investment funds in response to the evolution of an economy's relative information processing cycle (IPC). Specifically, and the level and variance of the economy's relative information processing ratio (IPR). A fund comprises a plurality of assets (e.g., stocks, bonds, currencies, gold, silver, oil, gas, cryptocurrencies such as bitcoin, ethereum, and the like, and cryptocurrencies which themselves are portfolios of plurality of assets, and cryptocurrencies whose value is determined by other assets). As the economy's relative information processing cycle (IPC) evolves and the relative information processing ratio rises the portfolio may be adjusted to become less conservative. As economy's relative information processing cycle (IPC) and relative information processing ratio (IPR) falls the portfolio may be adjusted to become more conservative. As the economy's relative information processing cycle (IPC) evolves and the relative information processing ratio variance rises the portfolio may be adjusted to become more conservative. As economy's relative information processing cycle (IPC) and relative information processing ratio variance (IPR) falls the portfolio may be adjusted to become less conservative. The level and variance of relative information processing ratio may be used in conjunction to adjust a portfolio.

### RELATED MATERIAL

Parker, E. The Entropic Linkage between Equity and Bond Market Dynamics. Entropy 2017, 19, 292.

### DETAILED DESCRIPTION AND BACKGROUND

Traditional strategic asset allocation methods can suffer huge losses from the inevitable changes in economic conditions over time. To better deal with these challenges regime based strategies attempt to adjust the portfolio to the current state of the economy. In regime based asset allocation the evolution of the economy is described by typically 2-4 regimes which are detected by means of hidden markov models. Regime based models have been shown to have superior out of sample profitability when compared to more rigid investment structures. This article introduces the concept of dynamic asset allocation and portfolio rebalancing via an economy's relative information processing ratio. This new information theory based investment method offers advantages over both traditional and regime based asset allocation methods.

Determining the proper number of regimes to include in MRSM is an important but unsolved problem. (Kasashara and Shimotsu 2018). Too few or too many regimes and the data series cannot be properly modeled (Cavicchioli 2013). “In practice the state dimension of the Markov chain is sometimes dictated by the actual application or it is determined in an informal manner . . . ” (Cavicchioli 2013). More formal mathematical methods such as the likelihood ratio test statistic fail for reasons such as “unidentifiable parameters, the true parameter being on the boundary of the parameter space, and the degeneracy of the Fisher information matrix . . . ” (Kasashara and Shimotsu 2018). Additionally there is no explicit justification to assume that the number of regimes is constant as the data series evolves.

Parker (2017) developed an alternative derivation of the yield curve. This derivation is based on Shannon type entropy or information loss as described by Ben-Naim (2017), and combined with Burnashev's formula for the error exponent of communication systems (Burnashev, 1976). An estimate of the information processing efficiency of the economy (R/C) could found using actual yield rates. An economy's relative information processing ratio will be denoted by R/C throughout.

Using this alternative derivation, Parker (2017) demonstrated that differing levels of R/C could generate the different regimes of the entropically derived yield curve. These regimes have an equivalent representation in the popular Nelson-Siegel specification of the yield curve (Nelson & Siegel, 1987). Parker 2017 examined the time evolution R/C during bull and bear markets. As demonstrated empirically R/C rises, reaches a maximum, and then falls in a cyclical pattern. The evolution of this information process provides a new and intuitive explanation of the boom and bust financial cycles as seen from an information theoretic perspective. Parker argued that this new variable reveals the actual cause of financial and business cycles, see Parker 2017.

Using this new variable R/C any traditionally constructed portfolio can be adjusted by utilizing the evolving level and variance of R/C. By adjusting portfolios to take into account the evolving R/C level and variance the portfolio's will automatically be dynamically optimized to the evolution of the business cycle. Unlike current methods such as hidden markov models, this new method is forward looking and uses all past data to project the future path of the economy. Hidden markov models assume only the last period of data is relevant and also look to determine the current state of the economy and not the future evolution.

As the R/C level and variance predictable vary over the business cycle a portfolio can be adjusted utilizing R/C. This adjust may be accomplished by many methods including proportionately adjusting the portfolio from 100% equity at the maximum level of R/C (seen to be 1.27 or near 1.27 in pervious cycles) to 100% bonds or other similarly conservative investments at the minimum level of R/C (seen to be 0.95 or near 0.95 in pervious cycles) as demonstrated in Parker 2017.

Additionally, the variance of R/C can be utilized to determine when it is appropriate to modify a portfolio. As seen in Parker 2017 when the variance of R/C rises dramatically the emergence if a significant downturn such as a bear market is highly likely. A portfolio can be adjusted to be more conservative with increasing variance of R/C and more liberal with falling variance of R/C.

Both the level and variance of R/C can be utilized simultaneous to modify a portfolio as described above. In periods of declining R/C and/or rising variance the portfolio could be gradually shifted from a more liberal to a more conservative stance.

The adjustments could be directly proportional to scaled proportional changes in R/C level. For instance R/C could be divided into 33 equally space increments from 1.27 to 0.95 and the percent of a portfolio devoted to equities set to 100% at R/C=1.27. As R/C falls the portfolio could be adjusted to decrease the equity percentage by 3% for each 0.01 drop in R/C. At R/C=0.95 the percent of the portfolio allocated to equities would be 0% and the percent to bonds 100%.

Other methods such as weighting the amount of each adjustment could be utilized. For instance it may be desirable to modify the portfolio much more near the maximum or minimum levels of R/C and adjust much less for the values inbetween. Methods such as the inverse gaussian methods utilized to determine the probability distribution function of the time to reach a particular level of R/C could also be utilized to weight the portfolio.

### BRIEF DESCRIPTION OF THE FIGURES

FIG. 1. is a block diagram of an exemplary data processing system embodying the present invention.

FIG. 1 shows a block diagram of software and hardware components for implementing one embodiment of the present invention 100. Processor 102 is a conventional engineering workstation or other computer processor such as an Intel 80><86 or Pentium central processing unit (CPU), Motorola CPU, RISC CPU and the like. Processor 102 may also be coupled to other processors accessible over conventional communications channels or buses (not shown). Processor 102 is conventionally coupled to storage 104 which may be a magnetic disk storage, a CD storage unit, or other conventional computer data storage unit.

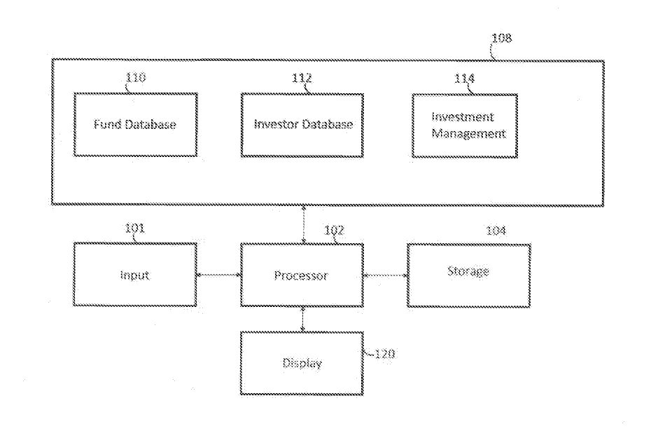

Storage 104 may also be coupled to other storage units accessible over conventional communications channels or buses (not shown).

Processor 102 is also conventionally coupled to memory 108 which is a random access memory (RAM) unit or other conventional computer memory. Items in memory 108 may alternatively be stored in storage 104 and accessed by processor 102 when required. Memory 108 may comprise a fund database 110 for storage and retrieval of information related to various funds (e.g., HT, LH, CB, Pvf, Risk Tolerance RI, and portfolios Pi—Pym), investor database 112 for storage and retrieval of information related to various investors (e.g., risk preference; preferences or constraints on investments such as domestic investments only, environ-mentally conscious investments, technology areas of investment, or industry areas of investment), and a strategic investment module or program component 114 as discussed below. Strategic investment program comprises a plurality of program instructions executable on processor 102.

Input 101 comprises conventional input devices such as a keyboard, mouse, track-ball, or touchscreen. A conventional display unit 120 may also be conventionally coupled to processor 102.

What is claimed is:

1. A computer system for managing assets in each of a plurality of investment funds, the system comprising:
a processor for executing programmed instructions and for storing and retrieving data; program memory, coupled to the processor, for storing program instructions for execution by the processor; an output device, coupled to the processor, for displaying data;
an input device, coupled to the processor, for accepting input data associated with each investment fund for storage in the memory, including:
R/C adjustment levels for each investment fund, and an actual investment mix among the assets in each investment fund; and
an investment program, stored in the memory and executable on the processor, for automatically and periodically:
determining for each investment fund a current relative investment level for the investment fund as a function of the relative information processing ratio R/C of an economy as determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants
determining a R/C adjusted asset mix for each investment fund as a function of the current R/C level, and modifying the investment mix of each investment fund as a function of the R/C adjusted asset mix.

2. The system of claim 1, wherein the asset mix is a strategic asset mix limited to assets for markets assumed to be in equilibrium, further comprising:
a tactical investment program, stored in the memory and executable on the Processor, for:
determining a tactical investment mix for the fund as a function of the strategic asset mix, the tactical investment mix consisting of assets for markets assumed to not be in equilibrium; and modifying the investment mix of the fund as a function of the tactical investment mix.

3. A computer implemented method for managing assets in an investment fund using a computer comprising a processor, storage, and a memory, the method comprising the steps of:
establishing, via the processor, an investment fund, the investment fund having an actual asset allocation including a plurality of assets, predetermined R/C adjustment levels for the investment fund, each asset in the asset allocation being a member of an asset class, each asset class having an asset class weight; periodically determining, via the processor, a current R/C adjusted asset mix for the investment fund as a function of the current R/C adjusted asset mix, the current R/C level determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
Where t is time to maturity of the bonds;
rₜ is the economy's yield curve rate at maturity t;
B₀ is the asymptotic long rate such as the 30-year bond yield rate;
Cₗ and σ are adjustment constants

4. The method of claim 3 wherein the asset classes include equity asset classes and income asset classes, and determining the current R/C level further comprises:
determining the R/C adjusted asset mix as a function of R/C level, the R/C adjusted asset mix allocating a majority of the assets in the R/C adjusted asset allocation to the equity asset classes when the R/C level is greater than a first predetermined level, and allocating a majority of the assets in the R/C adjusted asset allocation to the income asset classes when the R/C level is less than a second predetermined R/C level, where the first predetermined R/C level is greater than the second predetermined amount of R/C level.

5. The method of claim 3, wherein the step of periodically determining, via the processor, a R/C adjusted asset allocation further comprises: constraining the asset weight of at least one asset class to being less than a predetermined
percentage of a total of the asset weights for all asset classes in R/C adjusted asset allocation.

6. The computer-implemented method of claim 3 wherein there are a plurality of investment funds, the method further comprising: periodically and regularly repeating all steps for each investment fund.

7. The computer-implemented method of claim 3 further comprising the steps of:
allocating a first portion of the actual asset allocation to a strategic investment component limited to asset classes for markets assumed to be in equilibrium; allocating a second, remaining portion of the actual asset allocation to a tactical investment component limited to asset classes for markets assumed to not be in equilibrium, the tactical investment component having at least an equity asset allocation and an income asset allocation; determining, via the processor, an adjusted tactical investment allocation within the tactical investment component by:
allocating to the equity asset allocation a first portion of the tactical investment component corresponding to a portion of the strategic investment component allocated to equity asset classes; and allocating to the income asset allocation a second portion of the tactical investment component corresponding to a portion of the strategic investment component allocated to income asset classes; and purchasing or disposing of assets in the tactical investment component to match the adjusted tactical investment allocation.

8. The computer-implemented method of claim 7 wherein there are a plurality of investment funds, the method further comprising:
periodically and regularly repeating all steps for each investment fund.

9. The method of claim 7 wherein the asset classes include equity asset classes and income asset classes, and the step of determining the R/C adjusted asset allocation further comprises: determining the current R/C adjusted asset allocation as a function of a R/C level, the R/C adjusted asset allocation allocating a majority of the assets in the strategic investment component to the equity asset classes when the R/C level is greater than a first predetermined R/C level, and allocating a majority of the assets in the strategic investment component to the income asset classes when the R/C level is less than a second predetermined R/C level, where the first predetermined R/C level is greater than the second predetermined R/C level.

10. The computer-implemented method of claim 7 wherein the step of determining a tactical investment allocation comprises:
allocating E percent of the assets of the tactical investment component to the equity asset allocation, where E is equal to a percent of the strategic asset allocation allocated to equity asset classes; and
allocating (1−E) percent of the assets of the tactical investment component to the income asset allocation.

11. The computer-implemented method of claim 3 further comprising the steps of: distributing a second, remaining portion of the assets to a tactical investment component limited to asset classes for markets assumed to not be in equilibrium, the tactical investment component having at least an equity asset allocation and an income asset allocation; determining, via the processor, an adjusted tactical investment allocation for the fund by: allocating to the equity asset allocation E percent of the tactical investment component corresponding to a percent of the strategic investment component allocated to equity asset classes; and allocating to the income asset allocation (1−E) percent of the tactical investment component to the income asset allocation; modifying, via the processor, the investment mix of the fund as a function of the tactical investment mix; and purchasing or disposing of assets in the tactical investment component to match the adjusted tactical investment allocation.

12. In a computer system, including a processor and a memory, an investment program stored in the memory and executable by the processor for managing assets in each of a plurality of investment funds stored in the system, the investment program comprising:
an investment programs that accepts predetermined R/C adjustment levels for each investment fund and an actual investment allocation among assets in each investment fund, and that automatically and periodically:
determines for each investment fund an R/C adjusted allocation mix as a function of the current R/C level determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants

13. A computer implemented method for managing a plurality of investment funds, each investment fund having a R/C adjusted allocation mix, and an actual investment allocation of the assets in the investment fund, the method comprising:
automatically and periodically determining for each investment fund R/C adjusted allocation mix as a function of the current R/C level determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants

14. A computer system for managing assets in each of a plurality of investment funds, the system comprising:
a processor for executing programmed instructions and for storing and retrieving data; program memory, coupled to the processor, for storing program instructions for execution by the processor; an output device, coupled to the processor, for displaying data;
an input device, coupled to the processor, for accepting input data associated with each investment fund for storage in the memory, including:
R/C adjustment levels for each investment fund, and an actual investment mix among the assets in each investment fund; and
an investment program, stored in the memory and executable on the processor, for automatically and periodically:
determining for each investment fund a current relative investment level for the investment fund as a function of the relative information processing ratio R/C of an economy as determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants
determining a R/C adjusted asset mix for each investment fund as a function of the current variance of R/C, and modifying the investment mix of each investment fund as a function of the R/C adjusted asset mix.

15. The system of claim 1, wherein the asset mix is a strategic asset mix limited to assets for markets assumed to be in equilibrium, further comprising:
a tactical investment program, stored in the memory and executable on the processor, for:
determining a tactical investment mix for the fund as a function of the strategic asset mix, the tactical investment mix consisting of assets for markets assumed to not be in equilibrium; and modifying the investment mix of the fund as a function of the tactical investment mix.

16. A computer implemented method for managing assets in an investment fund using a computer comprising a processor, storage, and a memory, the method comprising the steps of:
establishing, via the processor, an investment fund, the investment fund having an actual asset allocation including a plurality of assets, predetermined R/C adjustment levels for the investment fund, each asset in the asset allocation being a member of an asset class, each asset class having an asset class weight; periodically determining, via the processor, a current R/C adjusted asset mix for the investment fund as a function of the current R/C adjusted asset mix, the current variance of R/C determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants

17. The method of claim 14 wherein the asset classes include equity asset classes and income asset classes, and determining the current R/C level further comprises:
determining the R/C adjusted asset mix as a function of current variance of R/C, the R/C adjusted asset mix allocating a majority of the assets in the R/C adjusted asset allocation to the equity asset classes when the current variance of R/C is less than a first predetermined level, and allocating a majority of the assets in the R/C adjusted asset allocation to the income asset classes when the current variance of R/C is greater than a second predetermined R/C level, where the first predetermined R/C level is greater than the second predetermined amount of R/C level.

18. The method of claim 14, wherein the step of periodically determining, via the processor, a R/C adjusted asset allocation further comprises: constraining the asset weight of at least one asset class to being less than a predetermined
percentage of a total of the asset weights for all asset classes in R/C adjusted asset allocation.

19. The computer-implemented method of claim 14 wherein there are a plurality of investment funds, the method further comprising:
periodically and regularly repeating all steps for each investment fund.

20. The computer-implemented method of claim 14 further comprising the steps of:
allocating a first portion of the actual asset allocation to a strategic investment component limited to asset classes for markets assumed to be in equilibrium; allocating a second, remaining portion of the actual asset allocation to a tactical investment component limited to asset classes for markets assumed to not be in equilibrium, the tactical investment component having at least an equity asset allocation and an income asset allocation; determining, via the processor, an adjusted tactical investment allocation within the tactical investment component by:
allocating to the equity asset allocation a first portion of the tactical investment component corresponding to a portion of the strategic investment component allocated to equity asset classes; and allocating to the income asset allocation a second portion of the tactical investment component corresponding to a portion of the strategic investment component allocated to income asset classes; and purchasing or disposing of assets in the tactical investment component to match the adjusted tactical investment allocation.

21. The computer-implemented method of claim 20 wherein there are a plurality of investment funds, the method further comprising:
periodically and regularly repeating all steps for each investment fund.

22. The method of claim 20 wherein the asset classes include equity asset classes and income asset classes, and the step of determining the current risk level further comprises: determining the current R/C adjusted asset allocation as a function of a current variance of R/C, the R/C adjusted asset allocation allocating a majority of the assets in the strategic investment component to the equity asset classes when the current variance of R/C is less than a first predetermined level, and
allocating a majority of the assets in the strategic investment component to the income asset classes when the current variance of R/C is greater than a second predetermined R/C level, where the first predetermined R/C variance is less than the second predetermined R/C variance.

23. The computer-implemented method of claim 20 wherein the step of determining a tactical investment allocation comprises:
allocating E percent of the assets of the tactical investment component to the equity asset allocation, where E is equal to a percent of the strategic asset allocation allocated to equity asset classes; and
allocating (1−E) percent of the assets of the tactical investment component to the income asset allocation.

24. The computer-implemented method of claim 14 further comprising the steps of: distributing a second, remaining portion of the assets to a tactical investment component limited to asset classes for markets assumed to not be in equilibrium, the tactical investment component having at least an equity asset allocation and an income asset allocation; determining, via the processor, an adjusted tactical investment allocation for the fund by: allocating to the equity asset allocation E percent of the tactical investment component corresponding to a percent of the strategic investment component allocated to equity asset classes; and allocating to the income asset allocation (1−E) percent of the tactical investment component to the income asset allocation; modifying, via the processor, the investment mix of the fund as a function of the tactical investment mix; and purchasing or disposing of assets in the tactical investment component to match the adjusted tactical investment allocation.

25. In a computer system, including a processor and a memory, an investment program stored in the memory and executable by the processor for managing assets in each of a plurality of investment funds stored in the system, the investment program comprising:
an investment programs that accepts predetermined R/C adjustment levels for each investment fund and an actual investment allocation among assets in each investment fund, and that automatically and periodically:
determines for each investment fund an R/C adjusted allocation mix as a function of the current variance of R/C determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants

26. A computer implemented method for managing a plurality of investment funds, each investment fund having a R/C adjusted allocation mix, and an actual investment allocation of the assets in the investment fund, the method comprising:
automatically and periodically determining for each investment fund R/C adjusted allocation mix as a function of the current variance of R/C determined by:
$${r}_{t} = {B}_{0} + \frac{ln ( \sqrt{t} )}{t} ( 1 - {e}^{- {C}_{1} ( 1 - \frac{R}{C} )} ) - \frac{ln ( σ )}{t} ( 1 - {e}^{- {C}_{1} ( 1 - \frac{R}{C} )} )$$
Where
$$\frac{R}{C}$$
is the economy's relative information processing ratio;
t is time to maturity of the bonds;
rₜ is the economy's yield curve rate at maturity t;
B₀ is the asymptotic long rate such as the 30-year bond yield rate;
Cₗ and σ are adjustment constants
